(19) United States
(12) Patent Application Publication
(10) Pub. No.: US 2014/0199910 A1
(43) Pub. Date: Jul. 17, 2014

(54) APPARATUS AND METHOD FOR REPAIRING ARRAY SUBSTRATE

(71) Applicant: Shenzhen China Star Optoelectronics Technology Co., Ltd., Shenzhen, Guangdong (CN)

(72) Inventors: Wen Da Cheng, Shenzhen (CN); Chu Jen Wu, Shenzhen (CN)

(73) Assignee: Shenzhen China Star Optoelectronics Technology Co., Ltd., Shenzhen, Guangdong (CN)

(21) Appl. No.: 13/824,392

(22) PCT Filed: Feb. 20, 2013
(86) PCT No.: PCT/CN2013/071699

§ 371 Date: Mar. 18, 2013

(30) Foreign Application Priority Data
Jan. 15, 2013 (CN) 201310013800.2

(51) Int. Cl. G02F 1/13

(52) U.S. Cl. CPC G02F 1/1303; G02F 1/1309
USPC 445/2; 445/61

(57) ABSTRACT

An apparatus and method for repairing array substrate are provided, wherein the apparatus comprises the following components: a laser source, operable to repair excess photoresist on the array substrate; a detection device, operable to detect whether there is excess photoresist on the array substrate; a filter lens, operable to make the light emitted from the laser source project onto the excess photoresist on the array substrate; the filter lens is arranged above the array substrate, the laser source is arranged above the filter lens, and the detection device is arranged above the array substrate. The apparatus and method for repairing array substrate of the present invention can be used for quick and accurate repair to an array substrate.

### FIELD OF THE INVENTION

The present invention relates to the technology of liquid crystal manufacturing, particularly to an apparatus and method for repairing array substrate.

### BACKGROUND OF THE INVENTION

In the manufacturing process of a liquid crystal array substrate, after the etching layer on the substrate is irradiated through a photomask, a pattern will be left on the etching layer after exposure. In such an operation, if the exposure is not sufficient, excess photoresist may exist in the pattern after exposure, and here the excess photoresist needs to be repaired. In the prior art, engineering personnel need to find the excess photoresist before manual positioning, and then the excess photoresist can be removed or repaired. Because of the sophisticated pattern structure formed on the array substrate, the method for manual positioning is complicated, and thus repair failures may be presented as positioning errors may often occur.

### CONTENTS OF THE INVENTION

The object of the present invention is to provide an apparatus and method for repairing array substrate, so as to overcome the defect that the repair failure may be presented because of positioning error with the prior array substrate repair technology. On one hand, an apparatus for repairing array substrate is provided, which comprises:

a laser source, operable to repair the excess photoresist on the array substrate;

a detection device, operable to detect whether there is the excess photoresist on the array substrate; and

a filter lens, operable to make the light emitted from the laser source project onto the excess photoresist on the array substrate so as to repair the excess photoresist;

wherein the filter lens is arranged above the array substrate, the laser source is arranged above the filter lens, and the detection device is arranged above the array substrate.

In the apparatus for repairing array substrate according to the present invention, the detection device comprises: an image collector, operable to collect a pattern on the array substrate; and an image comparing device, operable to compare the pattern on the array substrate with a preset target pattern to determine whether there is the excess photoresist.

In the apparatus for repairing array substrate according to the present invention, it further includes a display device which is connected to the detection device and operable to display the pattern on the array substrate.

In the apparatus for repairing array substrate according to the present invention, the filter lens includes a shading area and a transparent area, and the pattern of the shading area mates with a correct pattern on the array substrate.

An apparatus for repairing array substrate is provided in the present invention, which comprises:

a laser source, a detection device and a filter lens;

the detection device is operable to detect whether there is the excess photoresist on the array substrate; if there is the excess photoresist, a laser emitted from the laser source is projected onto the excess photoresist through the filter lens, so as to repair the excess photoresist.

In the apparatus for repairing array substrate according to the present invention, the detection device includes an image collector and an image comparing device which are interconnected; the pattern on the array substrate is collected by the image collector first, and then the collected pattern is compared with the preset target pattern by the image comparing device.

In the apparatus for repairing array substrate according to the present invention, the array substrate repair apparatus includes a display device, which is connected with the detection device and operable to display the pattern obtained by the detection device.

In the apparatus for repairing array substrate according to the present invention, the filter lens includes a shading area and a transparent area, and the pattern of the shading area mates with a correct pattern on the array substrate.

On the other hand, a method for repairing array substrate is provided, which includes:

detecting whether there is the excess photoresist on the array substrate;

if there is the excess photoresist, arranging the filter lens on the array substrate, and arranging the laser source on the filter lens, so that the laser emitted from the laser source can be projected onto the excess photoresist through the filter lens; and

exposing and repairing the excess photoresist with the laser emitted from the laser source.

In the method for repairing array substrate according to the present invention, the step of detecting whether there is the excess photoresist on the array substrate includes the following steps:

capturing the pattern on the array substrate; and

comparing the pattern on the array substrate with the preset target pattern.

In the method for repairing array substrate according to the present invention, it further includes displaying the pattern on the array substrate.

In the method for repairing array substrate according to the present invention, it further includes constructing a shading area and a transparent area on the filter lens, making the pattern of the shading area mating with a correct pattern on the array substrate.

With the apparatus and method for repairing array substrate according to the present invention, manual positioning is not necessary for repairing the excess photoresist on the array substrate, and the repair efficiency and repair quality are improved through the fast and accurate repairing to the array substrate with the filter lens.

### BRIEF DESCRIPTIONS OF THE DRAWINGS

The present invention will be described below with reference to the drawings, wherein:

FIG. 1 is a schematic drawing of the apparatus for repairing array substrate according to a preferred embodiment of the present invention;

FIG. 2.a is a schematic drawing of the array substrate under a normal state;

FIG. 2.b is a schematic drawing of the array substrate having the excess photoresist which is repaired by apparatus for repairing the array substrate shown in FIG. 1;

FIG. 2.c is a schematic drawing of the filter lens in the apparatus for repairing array substrate repair shown in FIG. 1;

FIG. 3 is a flow chart of the method for repairing array substrate according to a preferred embodiment of the present invention;

FIG. 4 is a schematic drawing of the array substrate in which the dark spot is repaired by the method shown in FIG. 3; and

FIG. 5 is a schematic drawing of the filter lens when the dark spot is repaired by the method shown in FIG. 3.

### DETAILED DESCRIPTION OF THE EMBODIMENTS

The present invention will be described below with reference to drawings and specific embodiments.

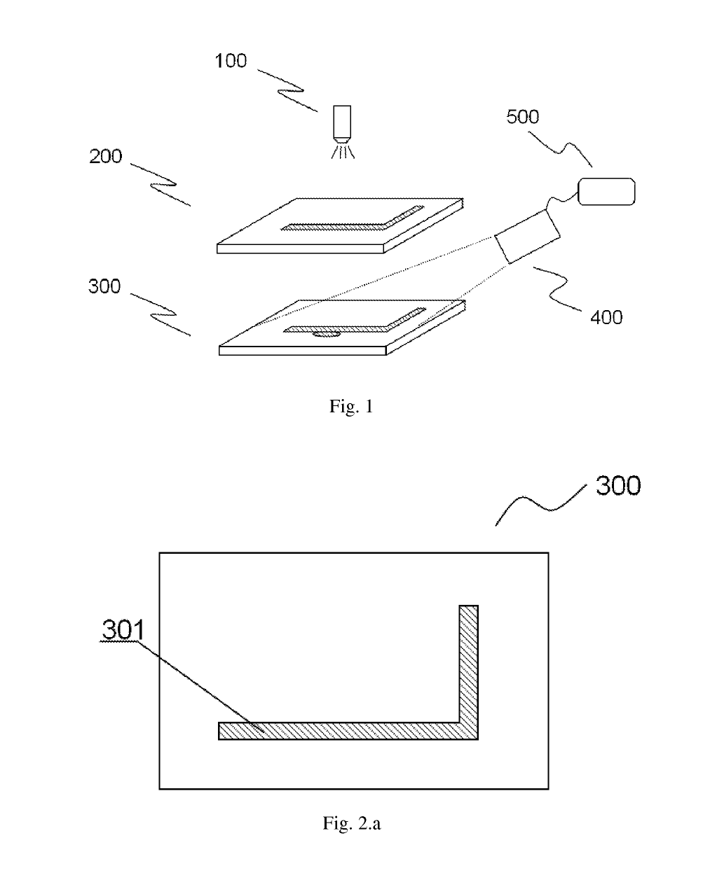

FIG. 1 is a schematic drawing of the apparatus for repairing array substrate according to a preferred embodiment of the present invention, wherein the array substrate 300 is a substrate that has been exposed and thus has a pattern left on its surface. The apparatus for repairing array substrate can be used to inspect and repair the pattern left on its surface.

A filter lens 200 is provided above the array substrate 300, which is provided with a shading area 201 and a transparent area 202, the shading area 201 is corresponding to the ideal etched pattern to be formed on the array substrate 300 originally. A laser source 100 is provided above the filter lens 200, the light emitted from which can pass the transparent area 202 of the filter lens 200 and be blocked completely by the shading area 201 simultaneously. Since the light of the laser source 100 is blocked by the shading area 201, only the excess photoresist on the array substrate 300 will be irradiated by the laser, but the normal area will not be irradiated.

In the embodiment, a detection device 400 is further provided for detecting whether there is the excess photoresist on the array substrate 300. An image collector and an image comparing device are provided inside the detection device 400, wherein the image collector is used to collect the pattern on the array substrate 300 that is compared by the image comparing device with a pre-stored target pattern, which can be the ideal etched pattern to be formed on the array substrate 300 originally. According to the portion of the pattern on the array substrate 300 inconsistent with the target pattern in the comparison result, it can be determined whether there is the excess photoresist on the array substrate. In order not to affect exposure of the laser source 100, the detection device 400 is arranged above it and has a certain tilt angle with respect to the array substrate 300. It needs to be explained that the position of the detection device 400 can also be adjusted according to actual demands, so long as it does affect exposure of the laser source 100; for example, the detection device 400 can be arranged right above the array substrate 300, and moved away again after the detection.

Preferably, the apparatus for repairing array substrate according to the present invention further includes a display device 500 connected to the detection device 400, the display device 500 can be used to displaying the image captured by the detection device 400 to an operator thus enabling the operator to see the repair effects.

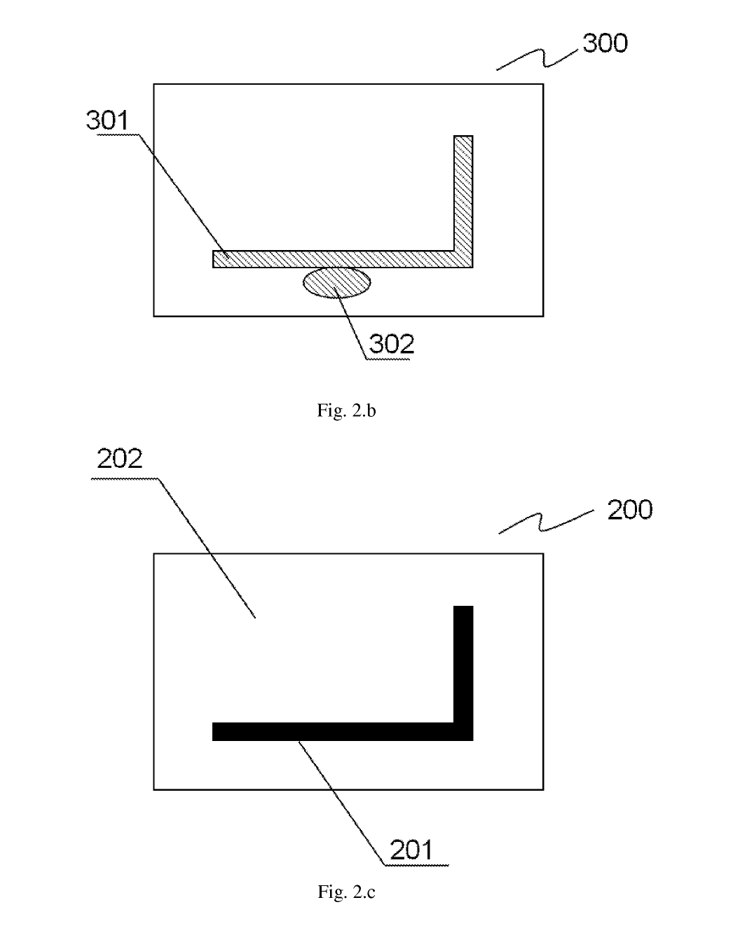

The effects of the present invention will be described below with reference to FIG. 2.a-FIG. 2.c. FIG. 2.a shows the array substrate 300 under a normal state, wherein the desired photolithographic pattern 301 may be left on the array substrate 300 after having been etched. When the etching effect is not good enough and the excess photoresist is produced, the effect may be shown in FIG. 2.b, wherein on the array substrate 300 there is the excess photoresist 302 in addition to the photolithographic pattern 301, with the excess photoresist 302 not necessary to be removed and simultaneously not affecting the photolithographic pattern 301. In order to attain the above purpose, the filter lens 200 is provided with a shading area 201 and a transparent area 202, as shown in FIG. 2.c, wherein the pattern of the shading area 201 matches the photolithographic pattern 301, such that the photolithographic pattern 301 of the array substrate 300 will not be affected by the laser source 100 when the laser source 100 has irradiated the filter lens 200. The excess photoresist 302 is removed after being exposed to the laser, thereby producing the array substrate shown in FIG. 2.a.

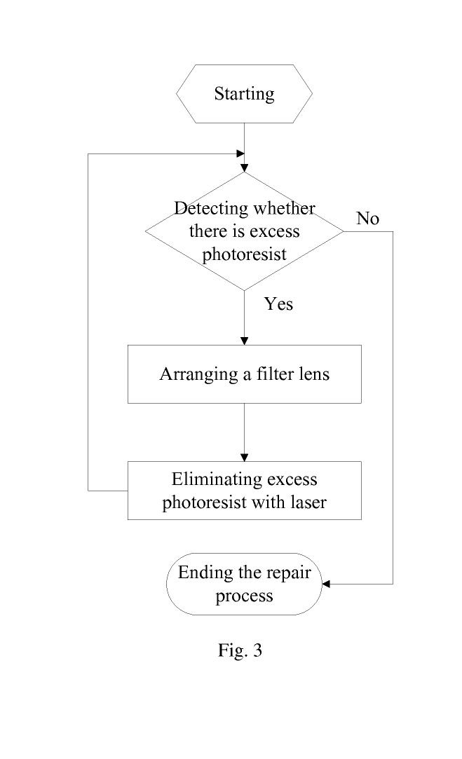

Specifically, the process adopted by the apparatus for repairing array substrate is shown in the flow chart of FIG. 3. First detecting whether there is the excess photoresist on the array substrate 300 to be repaired with the detection device 400, the method for detecting is as follows: collecting images for the array substrate 300 through the image collector in the detection device 400, and then comparing the collected images with the preset target pattern (i.e., the expected ideal pattern) by the image comparing device to determine whether there is the excess photoresist.

If there is no excess photoresist, the detection and repair process in this turn is over; otherwise the following repair process is needed: the filter lens 200 is provided, such that the shading area on the filter lens 200 can just block the normal photolithographic pattern 301 completely, making the normal photolithographic pattern 301 not be irradiated by the laser, with the light emitted from the laser source 100 passing through the transparent area and projected onto other positions on the array substrate 300, thereby getting the excess photoresist 302 repaired.

After the repair, the detection device 400 re-detects whether there is the excess photoresist, and if there is, the repair process will be repeated, until the excess photoresist is repaired.

The apparatus and method for repairing array substrate according to the present invention can be used for welding when repairing the dark spot of the array substrate.

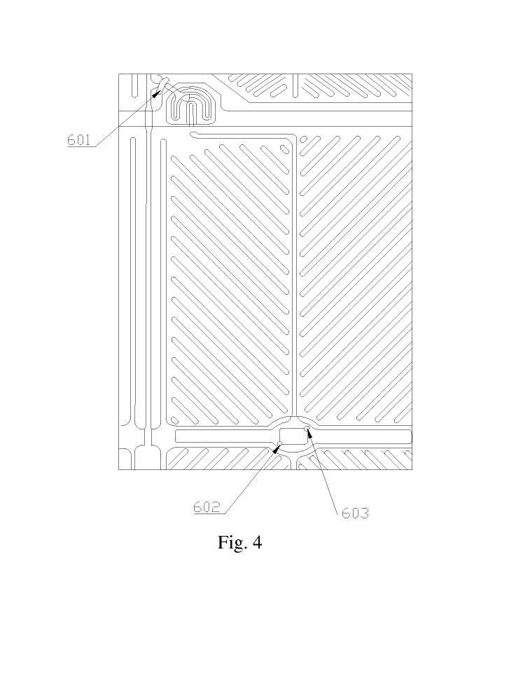

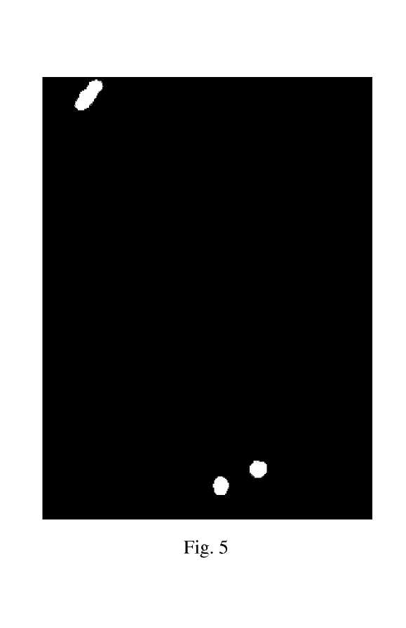

FIG. 4 shows an array substrate in which the dark spot is repaired, during which welding is needed at fixed spots, a first spot 601, a second spot 602, and a third spot 603, in the welding process, any affection cannot be made to the wiring at other positions substantially. Because the welding position is unchanged in the pattern, a piece of filter lens (e.g., the above filter lens 200) can be used to assist welding, as shown in FIG. 5. The filter lens in FIG. 5 is set to allow penetration of the laser at the first spot 601, the second spot 602, and the third spot 603, while blockage of the laser at the other positions (i.e., the black portion in FIG. 5). Because all the spots except the above three spots on the substrate are blocked by the filter lens, the quality of welding is improved. Besides, the same apparatus can be used for the above repair of the array substrate and welding of the fixed spot, with the distinction only in the different filter lens. Therefore, the versatility of the liquid crystal manufacturing device is improved, lowering the cost of the liquid crystal manufacturing process.

What described above are only the specific embodiments of the present invention, and cannot be used to limit the scope of the present invention. All the equivalent changes made by those of ordinary skill in the art according to the present invention and all the changes well known by those of ordinary skill in the art shall still fall within the scope of the present invention.

1. An apparatus for repairing array substrate, wherein, it comprises:
a laser source, operable to repair the excess photoresist on the array substrate;
a detection device, operable to detect whether there is the excess photoresist on the array substrate; and
a filter lens, operable to make the light emitted from the laser source project onto the excess photoresist on the array substrate so as to repair the excess photoresist;
the filter lens is arranged above the array substrate, the laser source is arranged above the filter lens, and the detection device is arranged above the array substrate.

2. The apparatus for repairing array substrate of claim 1, wherein, the detection device comprises: an image collector, operable to collect a pattern on the array substrate; and an image comparing device, operable to compare the pattern on the array substrate with a preset target pattern to determine whether there is the excess photoresist.

3. The apparatus for repairing array substrate of claim 2, wherein, it further includes a display device which is connected to the detection device and operable to display the pattern on the array substrate.

4. The apparatus for repairing array substrate of claim 1, wherein, the filter lens includes a shading area and a transparent area, and the pattern of the shading area mates with a correct pattern on the array substrate.

5. An apparatus for repairing array substrate, wherein, it comprises:
a laser source, a detection device and a filter lens;
the detection device is operable to detect whether there is the excess photoresist on the array substrate; if there is the excess photoresist, a laser emitted from the laser source is projected onto the excess photoresist through the filter lens, so as to repair the excess photoresist.

6. The apparatus for repairing array substrate of claim 5, wherein, the detection device includes an image collector and an image comparing device which are interconnected; the pattern on the array substrate is collected by the image collector first, and then the collected pattern is compared with the preset target pattern by the image comparing device.

7. The apparatus for repairing array substrate of claim 6, wherein, the array substrate repair apparatus includes a display device, which is connected with the detection device and operable to display the pattern obtained by the detection device.

8. The apparatus for repairing array substrate of claim 5, wherein, the filter lens includes a shading area and a transparent area, and the pattern of the shading area mates with a correct pattern on the array substrate.

9. A method for repairing array substrate, wherein, it includes:
detecting whether there is the excess photoresist on the array substrate;
if there is the excess photoresist, arranging the filter lens on the array substrate, and arranging the laser source on the filter lens, so that the laser emitted from the laser source can be projected onto the excess photoresist through the filter lens; and
exposing and repairing the excess photoresist with the laser emitted from the laser source.

10. The method for repairing array substrate of claim 9, wherein, the step of detecting whether there is the excess photoresist on the array substrate includes the following steps:
capturing the pattern on the array substrate; and
comparing the pattern on the array substrate with the preset target pattern.

11. The method for repairing array substrate of claim 9, wherein, it further includes displaying the pattern on the array substrate.

12. The method for repairing array substrate of claim 9, wherein, it further includes constructing a shading area and a transparent area on the filter lens, making the pattern of the shading area mating with a correct pattern on the array substrate.
